(19) United States
(12) Patent Application Publication
(10) Pub. No.: US 2026/0030243 A1
(43) Pub. Date: Jan. 29, 2026

(54) KNOWLEDGE GRAPH CONSTRUCTION AND APPLICATION FOR IMPROVING SEARCH RECALLS

(71) Applicant: Zoom Video Communications, Inc., San Jose, CA (US)

(72) Inventors: Jianbing Han, Los Gatos, CA (US); Ying Lu, Cerritos, CA (US); Kai Ni, Sammamish, WA (US); Jun Tan, Pittsburch, PA (US); Wang Tian, Hefei (CN)

(73) Assignee: Zoom Video Communications, Inc., San Jose, CA (US)

(21) Appl. No.: 18/787,333

(22) Filed: Jul. 29, 2024

(51) Int. Cl. G06F 16/2453; G06F 16/901

(52) U.S. Cl. CPC G06F 16/24549; G06F 16/9024

(57) ABSTRACT

Systems and methods of knowledge graph construction are provided. A communication platform accesses communication data on the communication platform associated with an enterprise. The communication platform extracts a plurality of keywords from the communication data. The communication platform creates a knowledge graph comprising a plurality of nodes. The plurality of nodes comprises a plurality of keyword nodes. The communication platform identifies, using a graph random walk algorithm, one or more keyword nodes in the knowledge graph related to a first keyword node to link the first keyword node with the one or more keyword nodes. The communication platform determines a first keyword node embedding for the first keyword node by aggregating information associated with at least the first keyword node and the one or more keyword nodes using a graph convolutional network algorithm. The communication platform attaches the first keyword node embedding to the first keyword node in the knowledge graph.

### FIELD

The present application generally relates to information retrieval and more specifically relates to knowledge graph construction and application for improving search recalls.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionality to various client devices;

FIG. 2 shows an example system in which a chat and video conference provider provides chat and videoconferencing functionality to various client devices;

FIG. 3 shows an example system for establishing a virtual communication session;

FIG. 4 shows an example system that is configured for knowledge graph construction and application;

FIG. 5 shows an example process for knowledge graph construction;

FIG. 6 shows an example process for information retrieval using the knowledge graph constructed in FIG. 5;

FIG. 7 shows an example computing device suitable for use with example systems and methods for knowledge graph construction and application for improving search recalls.

### DETAILED DESCRIPTION

Examples are described herein in the context of knowledge graph construction and application for improving search recalls. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

In the realm of information retrieval, enhancing search recall is crucial for ensuring that users access relevant information effectively. Recognizing and incorporating synonymous or related keywords into search processes can significantly improve recall by capturing a broader range of relevant information. Synonymous keywords refer to different terms or phrases that convey similar meanings within a specific context. However, synonymous keywords words or related keywords may be unique for an organization or enterprise.

To improve search recall, a knowledge graph for an enterprise is constructed and used for identifying synonyms and other related words for a user query. By structuring information associated with an enterprise into interconnected nodes and edges, a knowledge graph links similar or related terms in the context of the enterprise, and thereby facilitating the automatic recognition of synonymous and related terms and their relationships.

A knowledge graph includes a network of nodes, which can include a layer of user nodes, a layer of entity nodes, and a layer of keyword nodes. The layer of user nodes includes user nodes representing user accounts associated with the enterprise on the communication platform. Each user node has its own user profile data. The layer of entity nodes includes entity nodes representing communication functionalities of the communication platform, for example video conferences, chat channels, phone calls, emails, messages, shared documents, whiteboards. Each entity node has its own metadata, such as time and users. The layer of keyword nodes includes keyword nodes representing keywords extracted from communication data.

In one example, a knowledge graph construction engine accesses communication data associated with an enterprise on a communication platform to extract keywords, such as names and topics. The knowledge graph construction engine determines links (or edges) among keyword nodes, entity nodes, and user nodes. For example, certain user nodes and entity nodes are connected with edges to represent different types of communication functionalities corresponding users have used. Meanwhile, there are edges between user nodes within the layer of user nodes representing the relationship between two user nodes, such as organizational hierarchy or co-participants. Similarly, edges within the layers of entity nodes represent the co-occurrences of the two types of communications. The edges between and within the layer of user nodes and the layer of entity nodes can be weighted to represent the strength of the relationship between users, the frequency of co-occurrence of communication functionalities, or the frequency that a user uses a communication functionality.

In some examples, the knowledge graph construction engine identifies one or more nodes related to a keyword node using a graph random walk algorithm. A walk path goes from a first node to a second node if the edge weight between the two nodes is greater than a threshold value. The walk path from a first keyword node to a second keyword node includes nodes within a predetermined degree of separation (e.g., 5 degrees of separation or 5 hops). For example, keywords “JD,” “John Doe,” and “CTO” can be identified as synonyms based on their linkage to a user node representing the CTO named “John Doe”, for a specific organization or enterprise. Also for example, keywords “JD” and “speech recognition” can be identified as related nodes based on their linkage to an entity node representing a meeting where JD (John Doe, or the CTO) talked about speech recognition. The knowledge graph construction engine determines a keyword node embedding by aggregating information associated with nodes that are identified as related to the keyword node using a graph convolution network algorithm. This way, synonymous or related keyword nodes tend to have similar node embeddings.

When a user affiliated with an enterprise enters a search query, a search engine extracts keywords from the search query and create a query embedding. The search engine accesses the knowledge graph associated with the enterprise to which the user is affiliated to identify additional keywords from the knowledge graph that are related to the search query, by comparing the search query embedding with the keyword node embeddings. The search engine then retrieves communication data based on the additional related keywords in addition to the search query.

Thus, by constructing and leveraging the knowledge graph, more relevant information is retrieved for a user query. A graph random walk algorithm is used to identify related or synonymous keywords. A graph convolutional network (GCN) algorithm is used to enrich keyword embeddings by aggregating information associated with related or synonymous keywords. Overall, using such knowledge graph associated with an enterprise improves search recalls for user queries.

This illustrative example is given to introduce the reader to the general subject matter discussed herein and the disclosure is not limited to this example. The following sections describe various additional non-limiting examples and examples of knowledge graph construction and application for improving search recalls.

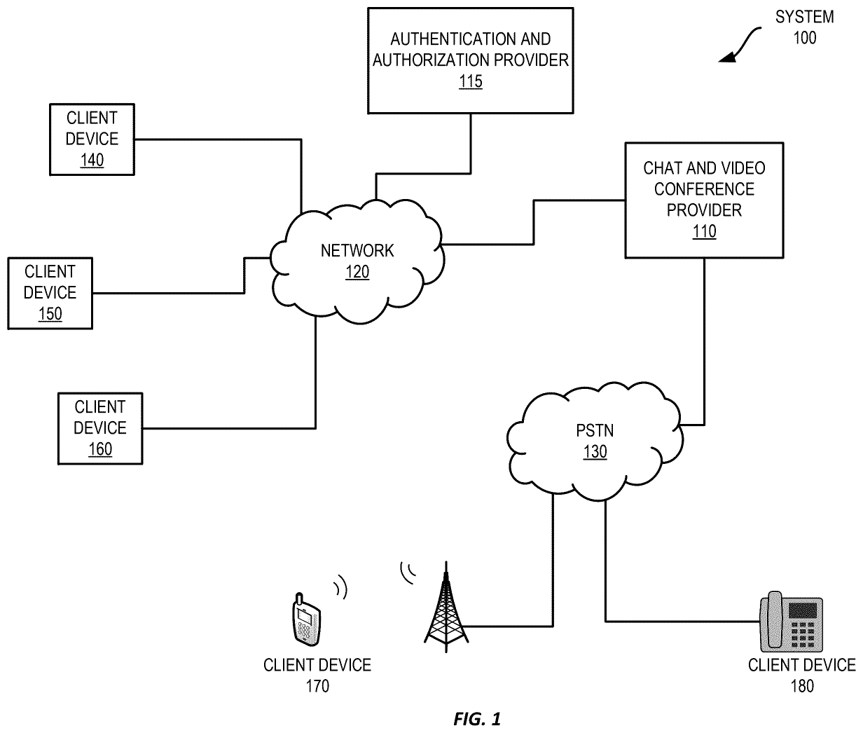

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

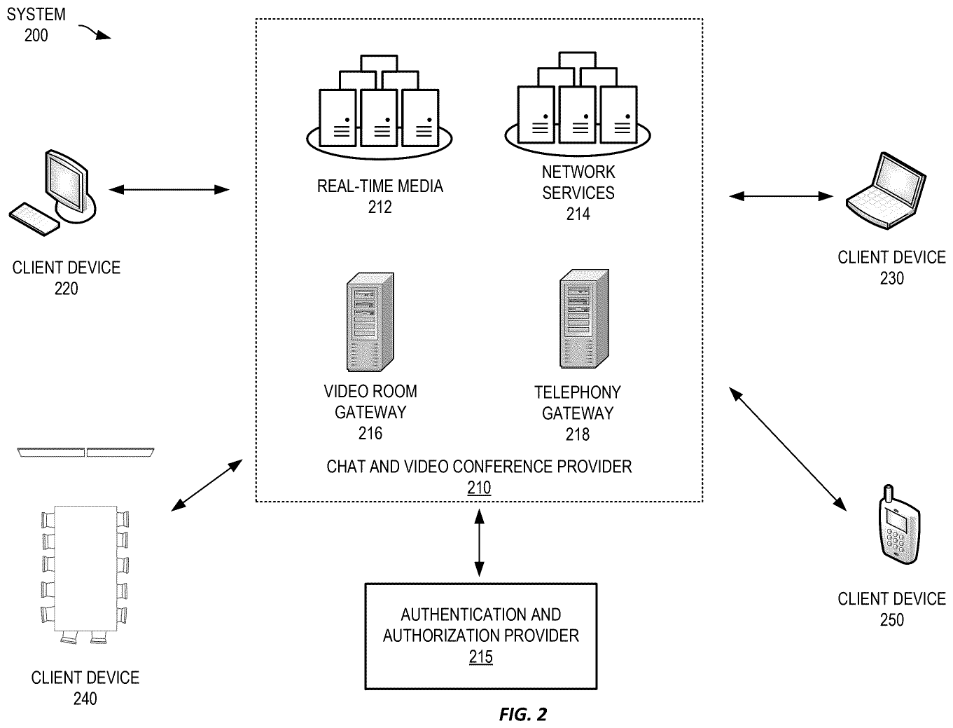

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

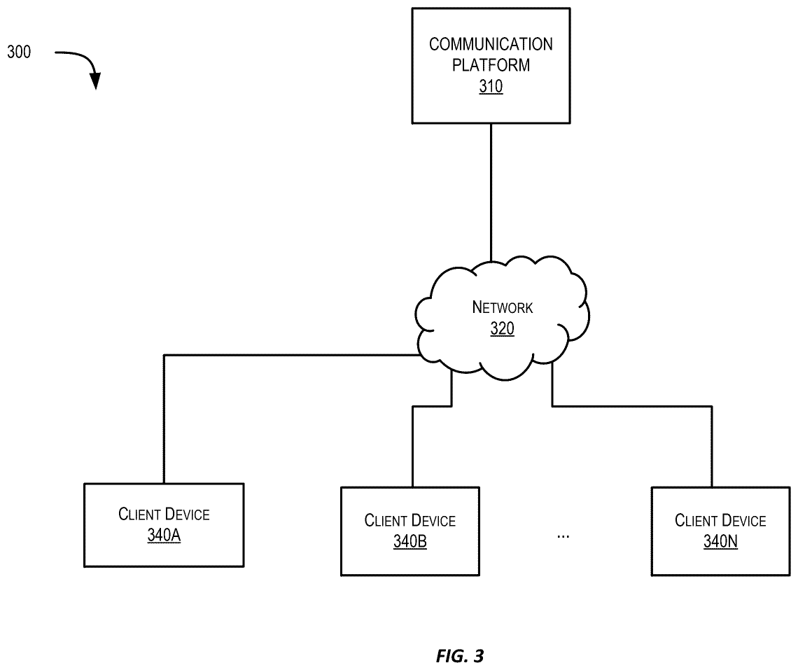

Referring now to FIG. 3, FIG. 3 shows an example system 300 for establishing a virtual communication session. In this example system 300, a communication platform 310 and a number of client device 340A-340N (which may be referred to herein individually as a client device 340 or collectively as the client devices 340) are connected via a network 320. The communication platform 310 can be any suitable communication platform, such as the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the communication platform 310 using the internet or other suitable computer network. The client devices 340 have communication software installed to enable them to connect to the communication platform 310 for chats, video conferences, emails, and any other suitable communications. For example, during a chat session, a user associated a client device (e.g., client device 340A) can interact with other users associated with other client devices (e.g., client device 340B-340N) via the communication platform 310 by sending and receiving chat messages, and reacting to received chat messages.

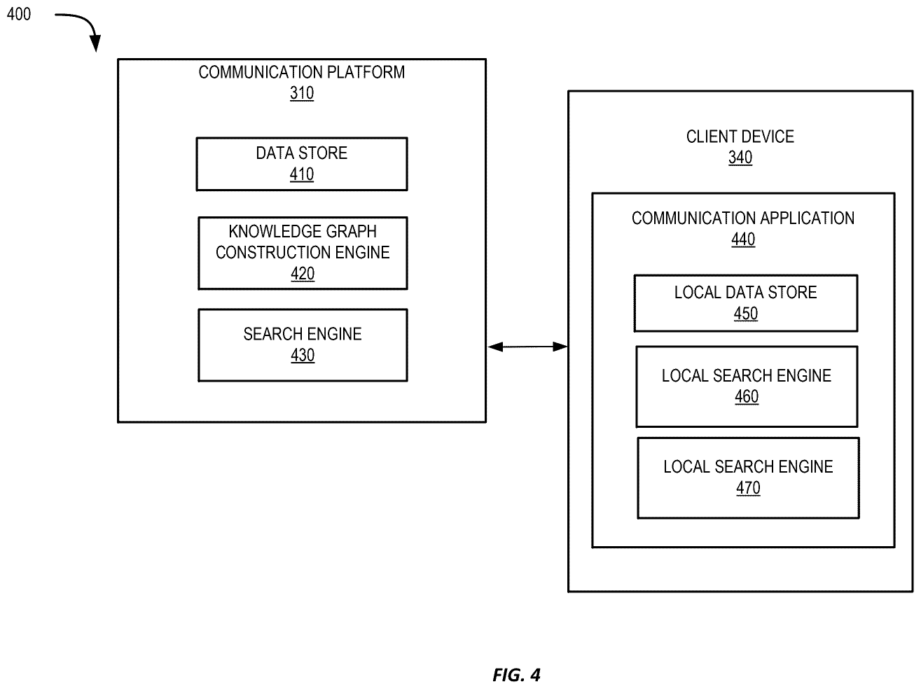

Referring now to FIG. 4, FIG. 4 shows an example system that is configured for knowledge graph construction and application. The communication platform 310 is in network communication with a client device 340. The communication platform 310 includes a data store 410, a knowledge graph construction engine 420, and a search engine 430.

The data store 410 stores communication data, organization data, user profile data, and other data related to an enterprise and users affiliated with the enterprise. The communication data can include video conference recordings, video conference transcripts, chat messages, emails, and other types of communication data. Each set of communication data has its own metadata, such as start time, end time, participants associated with a corresponding communication session, and a privacy setting. The privacy setting for a set of communication data can be public, that is, the set of communication data is available to all users affiliated with the enterprise on the communication platform. The privacy setting can be semi-public, that is, the set of communication data is available to a selected group of users (e.g., within a specific department, or with certain job titles) affiliated with the enterprise on the communication platform 310. The privacy setting can be private, that is, the set of communication data is only available to one user. The organization data includes hierarchical relationship data related to the users within the enterprise. User profile data includes occupation, job titles, education, location, hobbies, or any suitable personal data that a user shares on the communication platform 310. The communication data, organization data, user profile data, and other data associated with the enterprise are used to construct a knowledge graph for the enterprise, as will be described below. The data store 410 also stores the knowledge graph associated with an enterprise.

The knowledge graph construction engine 420 is configured to construct a knowledge graph based on communication data and other data associated with an enterprise. In some examples, the knowledge graph construction engine 420 uses or implements a keyword extraction algorithm to extract keywords from the communication data. Examples of the keyword extraction algorithm include a Rapid Automatic Keyword Extraction (RAKE) algorithm, a TextRank algorithm, or a Named Entity Recognition (NER) algorithm. Example keywords include names, places, dates, topics, and any suitable terms. In some examples, the knowledge graph construction engine 420 uses or implements certain normalization techniques to normalize the extracted keywords. Examples of keyword normalization includes removing stop words (e.g., “a,” “the,” “is,” “are,” etc.), “stemming” to remove the suffixes of extracted keywords to reduce them to their root or base form (e.g., using “program” to represent “programming,” “programmer,” and “programs”), “lemmatization” which replaces words with their canonical or dictionary form (e.g., using “run” to represent “running,” “runs,” and “ran.”), and group similar words to use one word (e.g., using one of the keywords “lawyer,” “counsel,” “attorney”) to represent all three keywords.

In some examples, the knowledge graph construction engine 420 constructs a knowledge graph including three layers of nodes-a layer of user nodes, a layer of entity nodes, and a layer of keyword nodes. The layer of user nodes includes user nodes representing user accounts associated with an enterprise on the communication platform 310. Each user node has its own user profile data. The layer of entity nodes includes entity nodes representing functionalities of the communication platform 310 that can be used by users on the communication platform 310, for example video conferences, chat channels, phone calls, emails, messages, shared documents, whiteboards, contacts, etc. The layer of keyword nodes includes keyword nodes representing keywords extracted from communication data associated with the enterprise. The keyword nodes may include metadata indicating from which portion of the communication data the corresponding keywords are extracted.

The knowledge graph construction engine 420 determines links (or edges) between user nodes within the layer of user nodes based on the hierarchical organization relationship, co-participation, or interaction frequency between the users. The knowledge graph construction engine 420 determines links between entity nodes based on co-occurrence of two communication functionalities. For example, documents sharing often happens during messaging, thus, entity node “docs” is linked to entity node “message.” Certain entity nodes and user nodes are linked to represent different types of communications functionalities the corresponding users have used.

The edges associated with the layer of user nodes and the layer of entity nodes can be weighted to represent the strength of the social relationship, the frequency of co-occurrence of communication functionalities, or the frequency that a user uses a communication functionality. For example, a link between two user nodes is weighted to represent the frequency of their interaction, a link between a user node and an entity node is weighted to represent how recently and how frequently the corresponding user uses the corresponding functionality of the communication platform 310, and the link between two entity nodes is weighted to represent how frequently the two functionalities are used together by different users.

The knowledge graph construction engine 420 determines the linkage between the user nodes and the keyword nodes and between the entity nodes and the keyword nodes, for example based on the metadata associated with the communication data. For example, certain keywords are extracted from a video conference session joined by certain participants. Corresponding keyword nodes are linked to the “video conference” entity node and some user nodes corresponding to the participants who uttered those keywords during the video conference session.

The knowledge graph construction engine 420 also determines linkages between keyword nodes. In some examples, the linkage between different keywords is straightforward. For example, the “artificial intelligence” and “machine learning” are two keywords that have similar semantic meanings. The knowledge graph construction engine 420 links these two corresponding keyword nodes based on natural language processing, which determines their respective semantic meaning and generates the link and a corresponding weight based on the similarity in semantic meaning. In some examples, two keywords do not have direct linkage based on apparent semantic similarities, but they may have a strong linkage based on their relationship with some user nodes or entity nodes. Such a relationship can be determined by analyzing different nodes within the knowledge graph.

The knowledge graph construction engine 420 uses or implements a graph random walk algorithm to identify a second keyword node related to a first keyword node and create a direct linkage between the two keyword nodes. In some examples, the graph random walk algorithm considers keyword nodes that are within a predetermined degree of separation (e.g., 5 degrees of separation or 5 hops) from a first keyword node. A frequency for a step from a node landing on the one or more neighboring nodes determined based on the linkage weights between the node and one or more neighboring nodes. If the linkage weight is greater than a predetermined threshold value, a path by the corresponding neighboring node is created. Multiple walk paths can be created from a keyword node to multiple keyword nodes in parallel simultaneously. A walk path from a first keyword node to a second keyword node includes one or more user nodes or entity nodes with the predetermined degree of separation. For example, a keyword node “JD” is linked to a user node “John Doe,” which is linked to an entity node “video conference.” If the link weight between the user node “John Doe” and the entity node “video conference” is greater than a predetermined threshold value, the walk path can go from the user node to the entity node. The entity node “video conference” is linked to another keyword node “speech recognition.” The walk path from the keyword node “JD” and keyword node “speech recognition” have 3 degrees of separation, within a predetermined 5 degree of separation threshold. Thus, a link can be created between the keyword node “JD” and the keyword node “speech recognition.” This way, the knowledge graph construction engine 420 identifies one or more keyword nodes related to a particular keyword node and creates direct links between the one or more keyword nodes and the particular keyword node. The nodes on the walk paths from the first keyword nodes create a neighborhood of nodes for the first keyword node, whose information can be used to determine the feature representation (e.g., embedding) for a keyword node.

In some examples, the knowledge graph construction engine 420 samples a subset of nodes related to a keyword node. The subset of nodes is selected within a predetermined degrees of distance based on linkage weights between different nodes. The knowledge graph construction engine 420 then aggregates information related to the subset of nodes using an aggregation algorithm. At each iteration or search depth, information associated with the local neighbors are aggregated. As the process iterates, more and more information is aggregated incrementally from nodes with further degrees of distance from the keyword node. The higher the linkage weight is, the more important the information associated with the neighboring node is in the aggregation. Examples of the aggregation algorithm include a mean aggregator, a long short-term memory (LSTM) aggregator, a pooling aggregator, a graph random walk algorithm, or a GCN algorithm. In some examples, the GCN algorithm used for information aggregation is trained based on optimizing a graph-based loss function via stochastic gradient descent to obtain optimized feature representations. The knowledge graph construction engine 420 or another engine on the communication platform 310 uses the aggregated information to generate a feature representation or embedding for the keyword node. This way, synonymous or related keyword nodes may have similar node embeddings. The keyword node embeddings are attached to corresponding keyword nodes in the knowledge graph.

The knowledge graph construction engine 420 updates the knowledge graph periodically based on updates in the communication data, organization data, or user profile data associated with the enterprise. Updates of the knowledge graph includes adding new nodes or new links, removing existing nodes or links, updating link weights, or updating keyword node embeddings. For examples, if certain links between a keyword node, a user node, and an entity node “video conference” is based on a video conference happened six months ago, the knowledge graph construction engine 420 can truncate the links as the linkage is outdated based on a predetermined threshold (e.g., 3 months). The knowledge graph construction engine 420 also updates the knowledge graph based on user feedback on generated answers to the user query. In some examples, the knowledge graph construction engine 420 partition the knowledge graph into multiple portions and update one portion at a time.

The search engine 430 identifies nodes in a knowledge graph that are related to a user query and retrieves communication data associated with the identified related nodes for providing an answer to the user query. The search engine 430 receives a user query from a client device 340 associated with a user affiliated with an enterprise. In some examples, the search engine 430 extracts keywords from the user query, using a keyword extraction algorithm, and creates a query embedding based on the extracted keywords. The search engine 430 accesses the knowledge graph associated with the enterprise to which the user is affiliated to identify nodes from the knowledge graph that are related to the search query. In some examples, the search engine 430 determines a similarity score (e.g., cosine similarity) for a keyword node by comparing the keyword node embeddings with the query embedding. The search engine 430 can identify keywords related to the user query based on a ranking of the similarity scores of the keyword node embeddings. Keywords whose similarity scores are greater than a predetermined threshold are selected as related keywords. Since related keyword nodes in the knowledge graph as constructed by the knowledge graph construction engine 420 have similar embeddings, they have close similarity scores, and multiple related keywords can be identified. In some examples, the search engine 430 identifies a first set of keyword nodes that are identical or synonymous to the query keywords, and then identifies a second set of keyword nodes that are connected to the first set of keyword nodes within a predetermined degree of distance using a graph random walk algorithm.

The search engine 430 retrieves communication data associated with the first set of keyword nodes and the second set of keyword nodes. In some examples, the search engine 430 identify relevant communication data based on metadata of the keyword nodes that indicating how to locate the communication data from where the keyword is extracted. In some examples, the search engine 430 searches the group of keywords in the communication data to identify and retrieve a set of communication data that contains the group of keywords. In some examples, the communication data are tagged with keywords that are included in the knowledge graph, the search engine 430 searches the tags of the communication data to identify the set of communication data that are tagged by the group of keywords. In some examples, the search engine 430 ranks the retrieved communication data and provides a set of communication data from the top of the ranking to generate an answer to the user search query. In some examples, the search engine 430 or another engine on the communication platform 310 provides the set of communication data to a generative artificial intelligence (AI) model to generate an answer to the user query.

With the knowledge graph, the search engine 430 can expand the search by identifying more keywords, including those that may not have semantically similarity to the query keywords but are uniquely related to the query keywords in the context of the enterprise. For example, a user query includes query keywords “meeting” and “JD.” The keyword nodes, such as “John Doe,” “CTO,” “computer scientist,” “speech recognition,” “machine translation,” are identified as related to the query keywords. Even though “CTO” and “speech recognition” and “machine translation” may not semantically similar to the query keywords, but they are strongly related to keyword nodes that are semantically similar to the query keywords.

The client device 340 is installed with a communication application 440 provided by the communication platform 310. The communication application 440 installed on the client device 340 can include a local data store 450, a local knowledge graph construction engine 460, and a local search engine 470. The local data store 450 stores communication data associated with communication sessions hosted or joined by a local user associated with the client device 340. The local knowledge graph construction engine 460 is configured to generate a knowledge graph based on communication data stored in the local data store 450 or other data on the communication platform 310 that is accessible to the client device 340, similar to the knowledge graph construction engine 420 as described above. The local search engine 470 is configured to search the local data store 450 or the data store 410 on the communication platform 310 based on a knowledge graph to identify relevant communication data for generating an answer to a user query, similar to the search engine 430 as described above.

The communication application 440 also includes a GUI for receiving user queries and displaying answers to user queries. In some examples, the GUI includes a search box for a user to enter a user query. In some examples, the GUI includes a chat box for a user to interact with chat bot representing the search engine 430 or the local search engine 470. The user can also provide user feedback on the answer, for example pressing or clicking a thumbs up or thumbs down button.

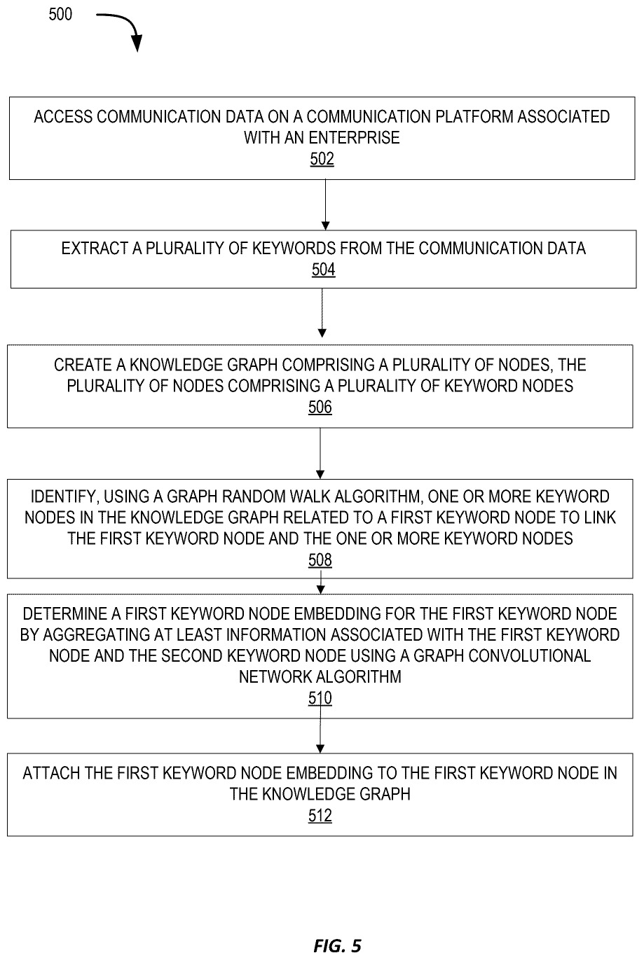

Referring now to FIG. 5, FIG. 5 shows an example process 500 for knowledge graph construction. The example process 500 will be discussed with respect to the system 400 shown in FIG. 4; however, any suitable system for knowledge graph construction may be used.

At block 502, a communication platform 310 accesses communication data on the communication platform associated with an enterprise. The knowledge graph construction engine 420 on the communication platform 310 accesses e communication data and other data associated with an enterprise on the communication platform 310 stored in the data store 410. The communication data can include video conference recordings, video conference transcripts, video conference summaries, phone call recordings, phone call summaries, emails, chat messages, and other types of communication data. Each set of the communication data has its own metadata, such as time and participants. The knowledge graph construction engine 420 also accesses user profile data related to the users within the enterprise and organization data including hierarchical relationship within the enterprise.

At block 504, the communication platform 310 extracts a plurality of keywords from the communication data. The knowledge graph construction engine 420 of the communication platform 310 uses or implements a keyword extraction algorithm to extract keywords from the communication data, generally as discussed above with respect to FIG. 4. In some examples, the knowledge graph construction engine 420 uses certain normalization techniques to normalize the extracted keywords. Examples of keywords include names, places, dates, topics, and any other suitable terms.

At block 506, the communication platform 310 creates a knowledge graph comprising a plurality of nodes, the plurality of nodes comprising a plurality of keyword nodes. The knowledge graph construction engine 420 of the communication platform 310 creates a knowledge graph for a particular enterprise, generally as described with respect to FIG. 4. In some examples, the knowledge graph includes a layer of user nodes, a layer of entity nodes, and a layer of keyword nodes. Each user node represents a user account associated with the enterprise on the communication platform 310. Each user node has its own user profile data. Each entity node represents a communication functionality of the communication platform 310, for example video conferences, chat channels, emails, messages, shared documents, whiteboards. Each entity node has its own metadata, such as use time, user frequency, and users. Each keyword node represents a keyword extracted from the communication data associated with the enterprise. Each keyword node may include metadata indicating from which portion of the communication data (e.g., time and title of a communication session, or a Uniform Resource Locator (URL) link to the communication data) the keyword is extracted.

At block 508, the communication platform 310 identifies, using a graph random walk algorithm, one or more keyword nodes in the knowledge graph related to a first keyword node to link the first keyword node with the one or more keyword nodes. The knowledge graph construction engine 420 determines links (or edges) between user nodes within the layer of user nodes, links between entity nodes within the layer of entity nodes, links between user nodes and entity nodes, the linkage between the user nodes and the keyword nodes, links between the entity nodes and the keyword nodes, generally as described in FIG. 4. In some examples, the edges associated with user nodes or entity nodes are weighted to represent the strength and recentness of their relationship. For example, the weight value can be between 0 and 1. Such weights can be updated periodically based on updates in communication data, user profile data, and organization data. A weight value of 1 represents the strongest relationship between two user nodes, maybe the users are direct reporting relationship within the enterprise. When the weight value is 0 or close to 0, the linkage between two nodes does not exist or can be removed.

The knowledge graph construction engine 420 also determines linkages between keyword nodes. In some examples, two keywords do not have direct linkage yet based on apparent semantic similarity, but they may have a strong relationship based on their relationship with some user nodes or entity nodes. The knowledge graph construction engine 420 uses or implements a graph random walk algorithm to identify a second keyword node related to a first keyword node and create a direct linkage between the first keyword node and the second keyword node, generally as described in FIG. 4. For example, a walk path forms from one node to another node if the weight of the link between the two nodes is greater than a predetermined threshold value. In some examples, only nodes within a predetermined degree of separation (e.g., 5 degrees of separation or 5 hops) from a keyword node are considered for the walk path from the keyword node. For example, the first keyword node is linked to a first user node (1 degree away), which is linked a second user (2 degrees away), which is linked to an entity node (4 degrees away), which is linked to a second keyword node (4 degrees away). Thus, the knowledge graph construction engine 420 identifies one or more keyword nodes related to a particular keyword node and creates direct links between the one or more keyword nodes and the particular keyword node.

At block 510, the communication platform 310 determines a first keyword node embedding for the first keyword node by aggregating at least information associated with the first keyword node and the one or more keyword node using a graph convolutional network algorithm. In some examples, the knowledge graph construction engine 420 samples a subset of nodes related to a keyword node. The subset of nodes is selected within a predetermined degrees of distance based on linkage weights between different nodes. The knowledge graph construction engine 420 then uses or implements a GCN algorithm to aggregate information related to the subset of nodes and related links at each search depth (e.g., degree of distance). The knowledge graph construction engine 420 uses the aggregated information to generate a feature representation or embedding for the keyword node.

At block 512, the communication platform 310 attaches the first keyword node embedding to the first keyword node in the knowledge graph. The knowledge graph construction engine 420 attaches the first keyword node embedding to the first keyword node in the knowledge graph. Keyword node embeddings represent features of the corresponding keyword nodes. The knowledge graph construction engine 420 updates a knowledge graph associated with an enterprise based on updates in the communication data, user profile data, or organization data associated with the enterprise. The knowledge graph can also be updated based on user feedback data.

The example process 500 illustrates a method for knowledge graph construction. However, not every step in the example process 500 may be needed, some other steps may be added, or the order of the steps may be changed. Alternatively, the example process 500 can be performed by a communication application 440 installed on a client device 340. After performing the example process 500 across the knowledge graph, each keyword node in the knowledge graph is attached with a keyword node embedding. Synonymous or related keyword nodes have similar embeddings.

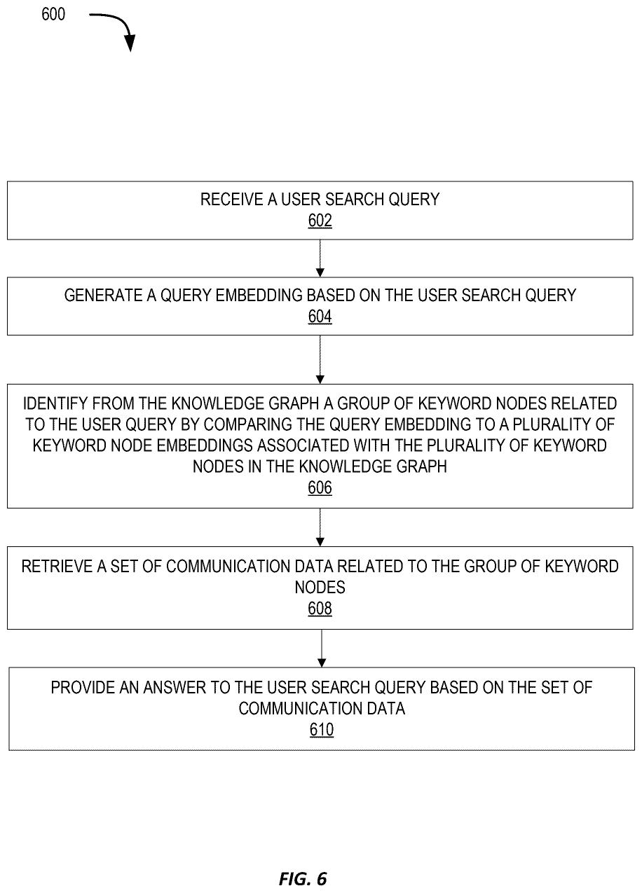

Referring now to FIG. 6, FIG. 6 shows an example process 600 for information retrieval using the knowledge graph constructed in FIG. 5. The example process 600 will be discussed with respect to the system 400 shown in FIG. 4; however, any suitable system for information retrieval using the knowledge graph constructed in FIG. 5 may be used.

At block 602, a communication platform 310 receives a user search query. The search engine 430 on the communication platform 310 receives a user search query. In some examples, a user enters the user search query via a GUI of a client device 340. The user search query can be a phrase including multiple words. Alternatively, or additionally, the user search query is a question including multiple words.

At block 604, the communication platform 310 generates a query embedding based on the user query. The search engine 430 extracts keywords from the user query and uses or implements an embedding model to generate a query embedding based on the extracted keywords from the user search query.

At block 608, the communication platform 310 identifies from the knowledge graph a group of keywords related to the user search query by comparing the user query embedding to a plurality of keyword node embeddings associated with the plurality of keyword nodes in the knowledge graph. In some examples, the search engine 430 determines a similarity score for a keyword node by comparing the query embedding and the keyword node embedding corresponding to the keyword node in the knowledge graph. If the similarity score is greater than a predetermined threshold value, the search engine 430 determines that the keyword node is relevant to the user search query. Since related keyword nodes in the knowledge graph as constructed by the knowledge graph construction engine 420 in FIG. 5 have similar embeddings, they have close similarity scores. Thus, the search engine 430 can identify a group of keyword nodes representing multiple keywords that are relevant to the user search query. The multiple keywords expand the user search query to include more related or relevant keywords, besides the words included in the user search query.

Alternatively, or additionally, the search engine 430 identifies a first set of keyword nodes that match the keywords in the user search query based on corresponding explicit semantic meanings or syntactic similarity. The search engine 430 then uses or implements a graph random walk algorithm to identify a second set of keyword nodes that are related to the first set of keyword nodes if the linkage weights are greater than a predetermined threshold value. The first set of keyword nodes and the second set of keyword nodes are both used for retrieving communication data to generate an answer to the user search query for the user search query.

At block 608, the communication platform 310 retrieves a set of communication data related to the group of keyword nodes. The search engine 430 retrieves communication data that are associated with the group of keyword nodes. The group of keyword nodes can be obtained using either or both methods as described at block 606. In some examples, the search engine 430 searches the group of keywords in the communication data to identify and retrieve a set of communication data that contains the group of keywords. In some examples, the communication data are tagged with keywords that are included in the knowledge graph, the search engine 430 searches the tags of the communication data to identify the set of communication data that are tagged by the group of keywords.

At block 610, the communication platform 310 provides an answer to the user search query based on the set of communication data. In some examples, the search engine 430 ranks the set of communication data retrieved at block 608. The ranking can be based on similarity scores of keyword node embeddings or degrees of distances of the associated keywords. The search engine 430 may select a portion of the set of communication data based on the ranking for generating an answer to the user search query. In some examples, the user search query is a question. The search engine 430 implements or uses a generative AI model to generate an answer to the user search query, based on the portion of the set of communication data. In some examples, the user search query is a phrase, the search engine 430 provides the URL links to the portion of the set of communication data as the response to the user search query.

The example process 600 illustrates a method for information retrieval using the knowledge graph constructed in the example process 500. However, not every step in the example process 600 may be needed, some other steps may be added, or the order of the steps may be changed. Alternatively, the example process 600 can be performed by a communication application 440 installed on a client device 340.

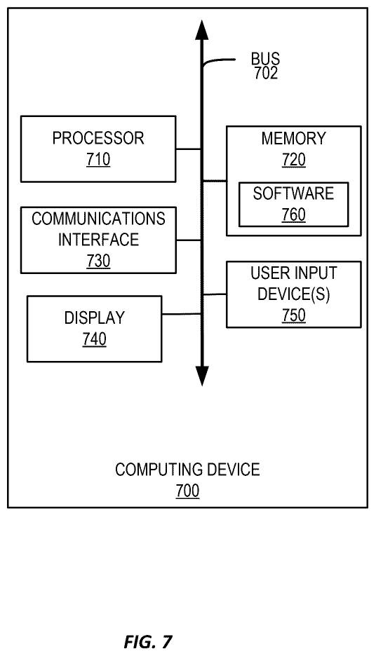

Referring now to FIG. 7, FIG. 7 shows an example computing device 700 suitable for use in example systems or methods for knowledge graph construction and application. The example computing device 700 includes a processor 710 which is in communication with the memory 720 and other components of the computing device 700 using one or more communications buses 702. The processor 710 is configured to execute processor-executable instructions stored in the memory 720 to perform one or more methods for resource management according to different examples, such as part or all of the example process 500 described above with respect to FIG. 5 and example process 600 with respect to FIG. 6. In some embodiments, the computing device may include software 760 for executing one or more methods described herein, such as for example, one or more steps of processes 500 and 600. The computing device 700, in this example, also includes one or more user input devices 750, such as a keyboard, mouse, touchscreen, microphone, etc., to accept user input. The computing device 700 also includes a display 740 to provide visual output to a user.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A method comprising:
accessing communication data on a communication platform associated with an enterprise;
extracting a plurality of keywords from the communication data;
creating a knowledge graph comprising a plurality of nodes, the plurality of nodes comprising a plurality of keyword nodes;
identifying, using a graph random walk algorithm, one or more keyword nodes in the knowledge graph related to a first keyword node;
linking the first keyword node with the one or more keyword nodes;
determining a first keyword node embedding for the first keyword node based at least on information associated with the first keyword node and the one or more keyword nodes using a graph convolutional network algorithm; and
attaching the first keyword node embedding to the first keyword node in the knowledge graph.

2. The method of claim 1, further comprising:
receiving a user search query;
determining a query embedding based on the user search query;
identifying from the knowledge graph a group of keyword nodes related to user query by comparing the query embedding to a plurality of keyword node embeddings associated with the plurality of keyword nodes in the knowledge graph;
retrieving a set of communication data related to the group of keyword nodes; and
providing an answer to the user search query based on the set of communication data.

3. The method of claim 2, further comprising:
determining a similarity score for a keyword node by comparing the query embedding and the keyword node embedding corresponding to the keyword node in the knowledge graph; and
in response to determining the similarity score is greater than a threshold value, retrieving a subset of communication data associated with the keyword node.

4. The method of claim 1, further comprising:
updating the knowledge graph based on updates in communication data associated with the enterprise periodically.

5. The method of claim 1, wherein the plurality of nodes further comprises a plurality of user nodes corresponding to a plurality of user accounts associated with the enterprise on the communication platform and a plurality of entity nodes corresponding to a plurality of functionalities on the communication platform.

6. The method of claim 5, wherein the knowledge graph is a weighted graph, wherein links between the plurality of user nodes and the plurality of entity nodes are weighted based on organization data associated with the enterprise and the communication data.

7. The method of claim 6, wherein identifying, using a graph random walk algorithm, one or more keyword node in the knowledge graph related to a first keyword node to link the first keyword node with the one or more keyword nodes comprises:
creating a walk path to a second keyword node within a predetermined degree of separation from the first keyword node in the weighted graph based on linkage weights of links associated with user nodes and entity nodes between the first keyword node and the second keyword node.

8. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access communication data on a communication platform associated with an enterprise;
extract a plurality of keywords from the communication data;
create a knowledge graph comprising a plurality of nodes, the plurality of nodes comprising a plurality of keyword nodes;
identify, using a graph random walk algorithm, one or more keyword nodes in the knowledge graph related to a first keyword node;
link the first keyword node and the one or more keyword nodes;
determine a first keyword node embedding for the first keyword node based at least on information associated with the first keyword node and the one or more keyword nodes using a graph convolutional network algorithm; and
attach the first keyword node embedding to the first keyword node in the knowledge graph.

9. The system of claim 8, wherein the one or more processors are configured to execute further processor-executable instructions stored in the non-transitory computer-readable medium to:
receive a user search query;
determine a query embedding based on the user search query;
identify from the knowledge graph a group of keyword nodes related to user query by comparing the query embedding to a plurality of keyword node embeddings associated with the plurality of keyword nodes in the knowledge graph;
retrieve a set of communication data related to the group of keyword nodes; and
provide an answer to the user search query based on the set of communication data.

10. The system of claim 9, wherein the one or more processors are configured to execute further processor-executable instructions stored in the non-transitory computer-readable medium to:
determine a similarity score for a keyword node by comparing the query embedding and the keyword node embedding corresponding to the keyword node in the knowledge graph; and
in response to determining the similarity score is greater than a threshold value, retrieve a subset of communication data associated with the keyword node.

11. The system of claim 8, wherein the one or more processors are configured to execute further processor-executable instructions stored in the non-transitory computer-readable medium to:
update the knowledge graph based on updates in communication data associated with the enterprise periodically.

12. The system of claim 9, wherein the plurality of nodes further comprises a plurality of user nodes corresponding to a plurality of user accounts associated with the enterprise on the communication platform and a plurality of entity nodes corresponding to a plurality of functionalities on the communication platform.

13. The system of claim 12, wherein the knowledge graph is a weighted graph, wherein links between the plurality of user nodes and the plurality of entity nodes are weighted based on social relation data and interaction data associated with the plurality of user nodes and the plurality of entity nodes.

14. The system of claim 13, wherein the one or more processors are configured to execute further processor-executable instructions stored in the non-transitory computer-readable medium to:
create a walk path to a second keyword node within a predetermined degree of separation from the first keyword node in the weighted graph based on linkage weights of links associated with user nodes and entity nodes between the first keyword node and the second keyword node.

15. A non-transitory computer-readable medium comprising processor-executable instructions configured to cause one or more processors to:
access communication data on a communication platform associated with an enterprise;
extract a plurality of keywords from the communication data;
create a knowledge graph comprising a plurality of nodes, the plurality of nodes comprising a plurality of keyword nodes;
identify, using a graph random walk algorithm, one or more keyword nodes in the knowledge graph related to a first keyword node;
link the first keyword node and the one or more keyword nodes;
determine a first keyword node embedding for the first keyword node based at least on information associated with the first keyword node and the one or more keyword nodes using a graph convolutional network algorithm; and
attach the first keyword node embedding to the first keyword node in the knowledge graph.

16. The non-transitory computer-readable medium of claim 15, further comprising processor-executable instructions configured to cause one or more processors to:
receive a user search query;
determine a query embedding based on the user search query;
identify from the knowledge graph a group of keyword nodes related to user query by comparing the query embedding to a plurality of keyword node embeddings associated with the plurality of keyword nodes in the knowledge graph;
retrieve a set of communication data related to the group of keyword nodes; and
provide an answer to the user search query based on the set of communication data.

17. The non-transitory computer-readable medium of claim 16, further comprising processor-executable instructions configured to cause one or more processors to:
determine a similarity score for a keyword node by comparing the query embedding and the keyword node embedding corresponding to the keyword node in the knowledge graph; and
in response to determining the similarity score is greater than a threshold value, retrieve a subset of communication data associated with the keyword node.

18. The non-transitory computer-readable medium of claim 15, wherein the plurality of nodes comprises a plurality of user nodes corresponding to a plurality of user accounts associated with the enterprise on the communication platform and a plurality of entity nodes corresponding to a plurality of functionalities on the communication platform, wherein the knowledge graph is a weighted graph, and wherein links between the plurality of user nodes and the plurality of entity nodes are weighted based on social relation data and interaction data associated with the plurality of user nodes and the plurality of entity nodes.

19. The non-transitory computer-readable medium of claim 18, further comprising processor-executable instructions configured to cause one or more processors to:
create a walk path to a second keyword node within a predetermined degree of separation from the first keyword node in the weighted graph based on linkage weights of links associated with user nodes and entity nodes between the first keyword node and the second keyword node.

20. The non-transitory computer-readable medium of claim 15, further comprising processor-executable instructions configured to cause one or more processors to:
update the knowledge graph based on updates in communication data associated with the enterprise periodically.
